(19) United States
(12) Patent Application Publication
(10) Pub. No.: US 2010/0279119 A1
(43) Pub. Date: Nov. 4, 2010

(54) METHOD FOR IMPROVING THE LONG TERM STABILITY OF NANO-CRYSTALLINE SEMICONDUCTORS

(75) Inventors: Michael Cleary, Merseyside (GB); Marcello Vitale, Merseyside (GB)

Correspondence Address: THE NATH LAW GROUP, 112 South West Street, Alexandria, VA, 22314, US

(73) Assignee: SMARTWATER RESEARCH LIMITED, Liverpool, Merseyside (GB)

(21) Appl. No.: 12/747,627

(22) PCT Filed: Dec. 12, 2008
(86) PCT No.: PCT/GB08/04090

§ 371 Date: Jun. 30, 2010

(30) Foreign Application Priority Data
Dec. 12, 2007 (GB) 0724298.5

(51) Int. Cl. B32B 27/04; B05D 5/06

(52) U.S. Cl. 428/407; 427/64

(57) ABSTRACT

A medium is provided in which nano-crystalline semiconductors or quantum dots are stable for extended periods when subjected to exterior lighting. The colour emission of the resultant quantum dots provides a fingerprint which is still effective after one year of exposure to exterior conditions. Such encapsulation protects the quantum dots in exterior conditions, so that they may be used as pigments or coding systems based on their optical emission.

The stability of nano-crystalline semiconductors or quantum dots (QD's) has been the subject of much development, however the stability of these materials in the unsheltered, exterior environment is still limited.

Photo-oxidative degradation of the semiconductor core, results in an etching of the surface, a smaller effective diameter and a corresponding blue shift in the emission λ maximum.

The reaction appears to be dependent upon the presence of light and oxygen and the absence of either one will stop this degradation. In terms of laboratory testing, it is much easier to eliminate light from an experiment than it is to totally eliminate oxygen in all its forms. However the exclusion of light from quantum dots actually, in use, in external environments is difficult and in most cases not practical.

In terms of increasing the stability of quantum dots in use, one option is the removal of oxygen and the prevention of the ingression of atmospheric oxygen to the extent necessary to stop the degradation.

Clearly the brightness of QD's means a very low concentration is required in most applications and so the concentration of dissolved oxygen or radicals present in the QD solution need only be at a correspondingly low level to cause degradation.

QD's emit across the visible and near infra-red regions of the spectrum. Combinations of dots can be used as a coding mechanism when applied as a surface coating to valuable or sensitive items. This is based on their optical emission when subjected to suitable stimulus, e.g. long wavelength U.V.

The problem currently is that this feature is only applicable to interior or shaded conditions. If conventional QD's are exposed to sunlight, then blue shift occurs meaning that the colour signature changes with time and is therefore unreliable.

It is therefore an object of the present invention to provide a medium in which the QD's are stable for extended periods when subjected to exterior lighting. The colour emission of the resultant encapsulated QD's provides a fingerprint which is still effective after one year of exposure to exterior conditions. Such encapsulation protects the quantum dot in exterior conditions, so that they may be used as pigments or coding systems based on their optical emission.

According to the present invention there is provided a method of encapsulating at least one quantum dot, comprising the step of:

coating said at least one quantum dot in a polymer medium.

Preferably, the step of coating said at least one quantum dot in a polymer medium is performed in the presence of air. Further preferably, said polymer medium is a cross-linked epoxy resin. In use, said cross-linked epoxy resin is optically clear.

Further preferably, the method further comprising the step of grinding said encapsulated at least one quantum dot to form a pigment. Preferably, said at least one quantum dot exhibits a unique fluorescence emission spectra.

Also according to the present invention there is provided an optically clear matrix comprising a plurality of quantum dots encapsulated in a polymer medium.

Preferably, said polymer medium is a cross-linked epoxy resin. Further preferably, in use, said plurality of quantum dots exhibit a unique fluorescence emission spectra.

Further according to the present invention there is provided a method of manufacturing unique identifying markers for tagging objects, said unique identifying markers being formed from a plurality of quantum dots which emit a unique fluorescence emission spectra, comprising the steps of:

encapsulating said plurality of quantum dots in an optically clear polymer medium; and

grinding said encapsulated plurality of quantum dots to form a pigment.

It is believed that the method and apparatus in accordance with the present invention at least addresses the problems outlined above. In particular, the advantages of the present invention are that a medium is provided in which the QD's are stable for extended periods when subjected to exterior lighting. Advantageously, the colour emission of the resultant QD's provides a fingerprint which is still effective after one year of exposure to exterior conditions. Further advantageously, such encapsulation protects the quantum dot in exterior conditions, so that they may be used as pigments or coding systems based on their optical emission.

It will be obvious to those skilled in the art the variations of the present invention are possible and it is intended that the present invention may be used other than as specifically described herein.

A specific non-limiting embodiment of the invention will now be described by way of example and with reference to the accompanying drawings, in which:

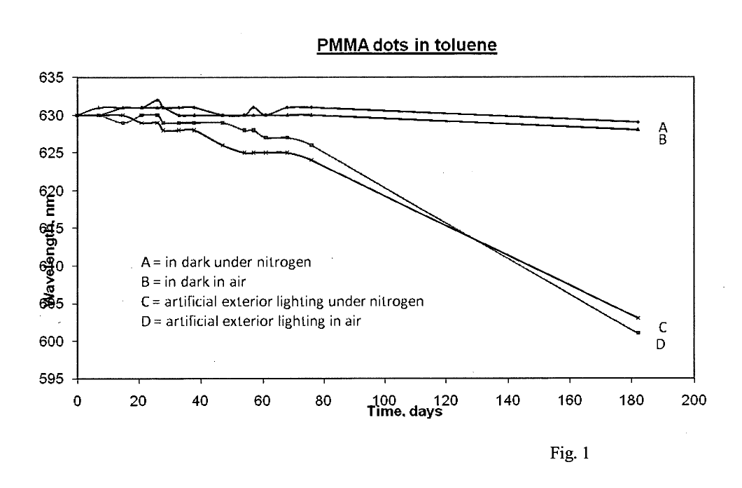

FIG. 1 illustrates the long-term stability of PMMA dots in toluene under various conditions.

The present invention provides a method of increasing the stability of quantum dots through the use of a polymer system which prevents oxidation and etching of the dot surface. The polymer systems studied provide clear, optically bright matrices in which the dots were entrapped. The invention described herein therefore shows that this increased stability is due to the ability of the polymer system to prevent or hinder the ingression of oxygen to the dot surface. The degradation of unencapsulated solutions of QD's in toluene was studied under the following conditions, as shown in FIG. 1:

A) under nitrogen and in darkness

B) in air and in darkness

C) under nitrogen and daylight

D) in air and daylight

The results obtained show that in darkened or interior lighting conditions no measurable degradation was evident, even though no measures were taken to remove or restrict the presence of oxygen.

However the exclusion of oxygen did not bring such conclusive results. Solutions of QD's in toluene were degassed with high purity gases, nitrogen and helium were both used. Further dry quantum dots were added to degassed toluene under a high purity nitrogen atmosphere. Using both these approaches the apparent exclusion/removal of oxygen did not produce the same level of improvement, although an effect could be seen and the inconclusive result could be due to incomplete removal of oxygen species, as noted in FIG. 1.

FIG. 1 shows that clearly the lack of light has an obvious effect, but the effect due to lack of oxygen is not so easily seen. The results indicate that it is likely that oxygen moieties are still present in the mixture at a level sufficient to degrade the QD's present. Further the QD's appear tolerant to low light levels as these produce no observed effect, it is only as the photon energy increases that degradation occurs.

Given that the applications of quantum dots as pigments or coding systems will be subject to exterior conditions, with high light intensities, the dots were then enclosed in an optically clear matrix that prevented or severely hindered the movement of oxygen moieties. Studies of the various forms of matrix, mostly with materials containing oxygen and/or nitrogen atoms, have been performed.

Several different types of matrix were analysed based on polymeric systems formulated as lacquers and adhesives. None provided any significant improvement over the results previously obtained.

Materials using separate resin and hardener, of which the main types are based on Polyurethane and Epoxy chemistries, were also analysed. The polyurethane systems did not provide any improvement, however the epoxy-based systems appeared to provide a barrier to oxygen/oxygen radical migration to the dot surface and degradation was correspondingly reduced.

This effect was checked more fully by adopting three different methods of protection for the dots, all performed under high purity nitrogen:
A=dots between two slides with the edges sealed with epoxy resin
B=dots coated in epoxy
C=dots simply sealed under a cellulose-based, pressure-sensitive adhesive tape layer

The experiment was performed in triplicate using accelerated ageing. An artificial weathering machine equipped with a xenon lamp and a daylight filter, set to provide a constant illumination of 713 W/m² measured between 300 and 800 nm, was used. Such illumination approximates to summer noontime sunlight in regions where overall solar light is 160 kLangleys/year, such as Florida or Arizona, therefore it is near the highest naturally occurring illumination rate. The test chamber temperature was kept constant, at 40° C., in order to avoid the effect of unnaturally high temperatures. The results are shown below in Table 1:

TABLE 1
Long term stability of encapsulated QD's in Nitrogen

| | 0 weeks | 1 week | 2 weeks | 3 weeks | 4 weeks | 5 weeks |
|---|---|---|---|---|---|---|
| Sample | (nm) | (nm) | (nm) | (nm) | (nm) | (nm) |
| A1 | 656 | 655 | 656 | 655 | 650 | 641 |
| A2 | 656 | 655 | 656 | 655 | 650 | 643 |
| A3 | 656 | 655 | 655 | 655 | 650 | 641 |
| B1 | 656 | 655 | 655 | 656 | 656 | 654 |
| B2 | 656 | 655 | 656 | 655 | 655 | 654 |
| B3 | 656 | 655 | 656 | 655 | 655 | 654 |
| C1 | 655 | 653 | 649 | 641 | 640 | — |
| C2 | 655 | 654 | 647 | 641 | 636 | — |
| C3 | 655 | 653 | 645 | 639 | 630 | — |

Clearly excellent results were obtained when the QD's were mixed in epoxy as in B. Both A and C indicate the presence of dissolved oxygen moieties present and still mobile in the mixture surrounding the dots.

The experiment was then repeated in air and shown in Table 2, where:
A=dots between two slides with the edges sealed with epoxy resin
B=dots coated in epoxy
C=dots simply sealed under a cellulose-based, pressure-sensitive adhesive tape layer

TABLE 2
Long term stability of encapsulated QD's in Air

| | 0 weeks | 1 week | 2 weeks | 3 weeks | 4 weeks | 5 weeks |
|---|---|---|---|---|---|---|
| Sample | (nm) | (nm) | (nm) | (nm) | (nm) | (nm) |
| A1 | 656 | Not vis. | | | | |
| A2 | 656 | Not vis. | | | | |
| A3 | 657 | Not vis. | | | | |
| B1 | 656 | 657 | 656 | 655 | 654 | 655 |
| B2 | 656 | 657 | 657 | 655 | 656 | 657 |
| B3 | 656 | 657 | 655 | 655 | 656 | 655 |
| C1 | 656 | 649 | 645 | 640 | 638 | 632 |
| C2 | 656 | 649 | 646 | 644 | 640 | 635 |
| C3 | 656 | 650 | 645 | 638 | 633 | 630 |

The results in case B show no movement in the emission of the QD's contained in the epoxy resin matrix. This medium has therefore prevented the degradation of the QD's under harsh external lighting.

The results in cases A and C show degradation a lot faster than previous and the experiment was stopped after one week. Clearly the results indicate a worsening in the A and C samples compared to the same experiment conducted under Nitrogen. This indicates that the mechanism does involve a significant involvement from atmospheric oxygen and its migration through the surrounding medium to the dot surface.

This degradation is hindered and considerably reduced by the structure of the epoxy system when surrounding the QD's and does mean that these materials can now be used externally in this medium.

Comparisons with other two-pack polymer systems were also made in which the dots were mixed directly into the two-pack systems as shown in Table 3, specifically for two pack polyurethane

TABLE 3

| | 0 | 1 |
|---|---|---|
| | weeks | week |
| Sample | (nm) | (nm) |
| Sample 1 | 653 | 637 |
| Sample 2 | 652 | 637 |
| Sample 3 | 652 | 643 |

These results indicated no real improvement had been achieved and the experiment was stopped after one week.

The final hard cross-linked epoxy resin containing QD's was then ground down into a powder and stability tests were undertaken again; such results showing that such encapsulation protects the quantum dot in exterior conditions.

This approach provides a relatively simple method of increasing the stability of QD's to the extent that they do have good exterior stability. It further provides a method of forming a pigment from the dots, small enough to be used in most forms of printing technology.

It further provides a matrix which uses the nano-material in a form which although small is definitely larger than nano-sized.

Various alterations and modifications may be made to the present invention without departing from the scope of the invention.

1. A method of encapsulating at least one quantum dot, comprising the step of:
coating said at least one quantum dot in an epoxy resin.

2. The method as claimed in claim 1, wherein the step of coating said at least one quantum dot in an epoxy resin is performed in the presence of air.

3. The method as claimed in claim 1, wherein said epoxy resin is a cross-linked epoxy resin.

4. The method as claimed in claim 3, wherein said cross-linked epoxy resin is optically clear.

5. The method as claimed in claim 1, further comprising the step of grinding said encapsulated at least one quantum dot to form a pigment.

6. The method as claimed in claim 1, wherein said at least one quantum dot exhibits a unique fluorescence emission spectra.

7. An optically clear matrix comprising a plurality of quantum dots encapsulated in an epoxy resin.

8. The optically clear matrix as claimed in claim 7, wherein said epoxy resin is a cross-linked epoxy resin.

9. The optically clear matrix as claimed in claim 1, wherein said plurality of quantum dots exhibit a unique fluorescence emission spectra.

10. A method of manufacturing unique identifying markers for tagging objects, said unique identifying markers being formed from a plurality of quantum dots which emit a unique fluorescence emission spectra, comprising the steps of:
encapsulating said plurality of quantum dots in an optically clear epoxy resin; and
grinding said encapsulated plurality of quantum dots to form a pigment.

11. (canceled)
